(19) United States
(12) Patent Application Publication
(10) Pub. No.: US 2005/0235786 A1
(43) Pub. Date: Oct. 27, 2005

(54) Pads for handles of pliers

(76) Inventor: Wen Yueh-Chiang, Wu-Feng Hsiang (TW)

Correspondence Address: PRO-TECHTOR INTERNATIONAL SERVICES, 20775 Norada Court, Saratoga, CA, 95070-3018, US

(21) Appl. No.: 10/832,649

(22) Filed: Apr. 26, 2004

(51) Int. Cl. B25B 7/12

(52) U.S. Cl. 81/367

(57) ABSTRACT

A locking pliers comprises fixed and moveable handles each having a U-shaped section, fixed and moveable jaws, a toggle link pivotably interconnected the handles, a tension spring interconnected the moveable jaw and the fixed handle, a quick release pivotably connected to the moveable handle, an adjusting screw projected from a rear end of the fixed handle, and first and second pads in the form of sheet disposed over the handles respectively. The invention can provide the user with a degree of comfort while using the pliers.

### BACKGROUND OF THE INVENTION

1. Field of the Invention

The present invention relates to pads and more particularly to a pair of pads disposed over the handles of a pliers (e.g., locking pliers) for providing the user with a degree of comfort while using the pliers.

2. Description of Related Art

A conventional locking pliers is shown in FIG. 1. The pliers comprises a pair of handles 1 and 2 having a section of U, two serrated jaws 5 pivotably secured to the handles 1 and 2 at rivets 3 and 4 respectively, a toggle link 6 interconnected both handles 1 and 2, a tension spring 7 connected at one end to the jaw 5 and at the other end to a connector (not shown) within the handle 1, a quick release 8 pivotably connected at one end to the handle 2, and an adjusting screw 9 projected from a rear end of the handle 1.

The locking pliers is formed of a metallic material. Hence, the hand holding the handles of the pliers may slip while exerting force, for example, for gripping a small object. It is thus desirable to provide pads over the handles. Moreover, the present inventor is aware that it is impossible of forming pads integrally with handles in the manufacturing process of pliers since the pad is formed of polymeric material. Thus, continuing improvements in the exploitation of handles of pliers with pads disposed thereover are constantly being sought.

### SUMMARY OF THE INVENTION

It is an object of the present invention to provide a locking pliers comprising first and second handles each having a U-shaped section wherein the first handle is fixed and the second handle is moveable; first and second serrated jaws wherein the first jaw is fixedly secured to the first handle and the second jaw is pivotably secured to the first and second handles; a toggle link pivotably interconnected the first and second handles; resilient means connected at one end to the second jaw and at the other end to the first handle; a quick release pivotably connected to the second handle; an adjusting screw projected from a rear end of the first handle; and first and second pads in the form of sheet disposed over the first and second handles respectively. By utilizing the present invention, it is possible of providing the user with a degree of comfort while using the pliers.

In one aspect of the present invention the first pad is substantially rectangular and comprises an increased first section disposed over a portion of the first handle ranged from about the toggle link to a front end of the gap, a second section larger than the first section disposed over the rear end of the first handle with the gap being not enclosed, and at one end two spaced holes for leaving a joint of the first and second jaws open when the first pad is disposed over the first handle.

In another aspect of the present invention the second pad is substantially trapezoidal and comprises an indent at either side for leaving a joint of the second handle and the quick release, and at one end two spaced holes for leaving a joint of the second handle and the toggle link open when the second pad is disposed over the second handle.

The above and other objects, features and advantages of the present invention will become apparent from the following detailed description taken with the accompanying drawings.

### BRIEF DESCRIPTION OF THE DRAWINGS

FIG. 1 is a perspective view of a conventional locking pliers;

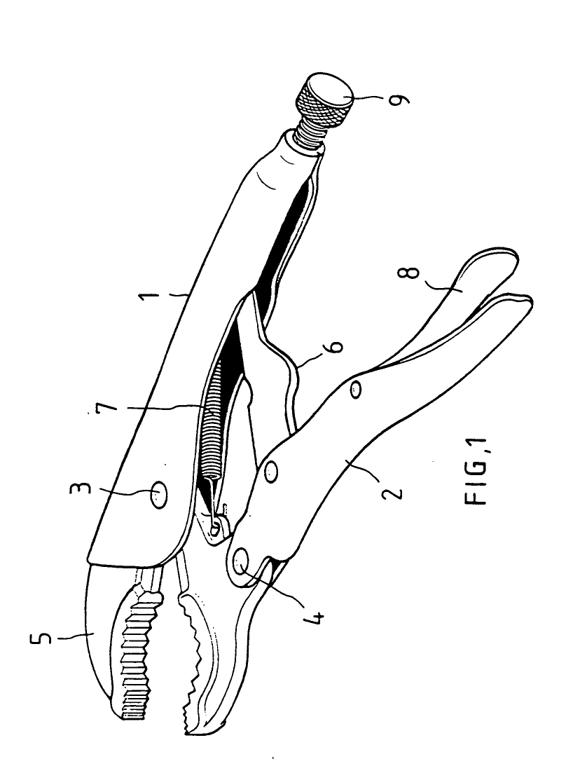

FIG. 2 is a perspective view of a first preferred embodiment of locking pliers according to the invention, where the pliers is in an open position;

FIG. 3 is an exploded perspective view of the pliers of FIG. 2 with a pair of pads being separated;

FIGS. 4 and 5 are plan views of the unfolded first and second pads of FIG. 2 respectively;

FIG. 6 is a view similar to FIG. 2, where the pliers is in a closed position;

FIGS. 7 and 8 are plan views of unfolded first and second pads according to a second preferred embodiment of the invention, the pads adapted to dispose over handles of a locking pliers; and

FIG. 9 is a perspective view of a locking pliers with the first and second pads of FIGS. 7 and 8 disposed over handles thereof, where the pliers is in a closed position.

### DETAILED DESCRIPTION OF THE PREFERRED EMBODIMENTS

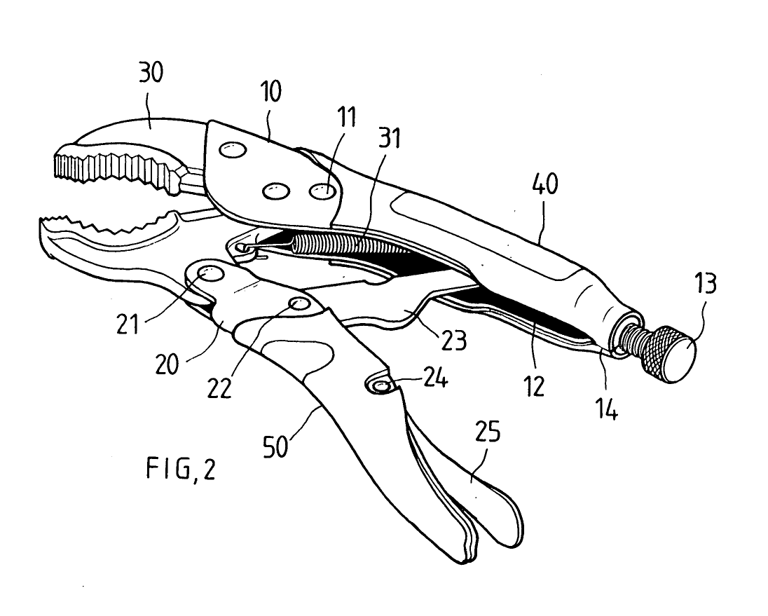

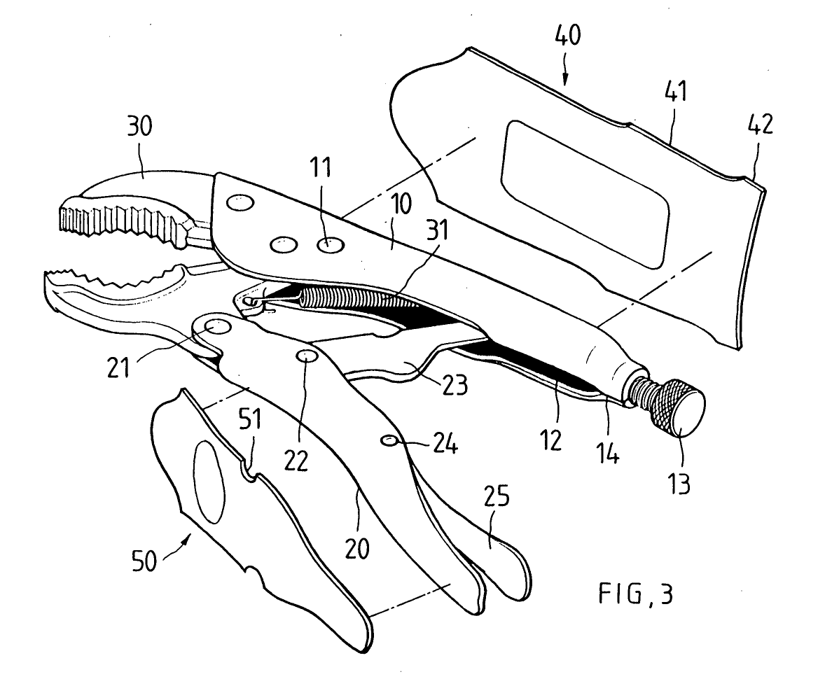

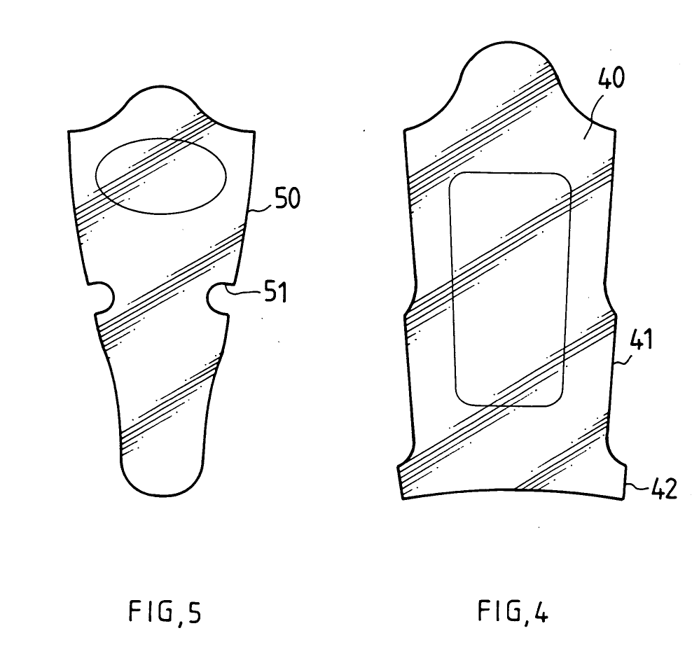

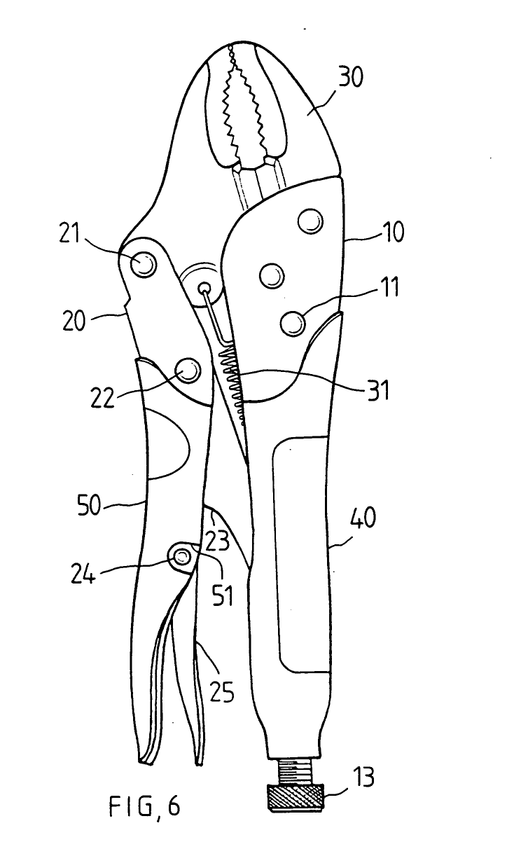

Referring to FIGS. 2 to 6, a first preferred embodiment of the invention is shown. A locking pliers comprises a fixed handle 10 having a U-shaped groove 12 and a reduced rear end with a lengthwise gap 14, a moveable handle 20 also having a section of U, two serrated jaws 30 pivotably secured to the handles 10 and 20 at rivets 11 and 21 respectively, a toggle link 23 having one end connected to the moveable handle 20 at a rivet 22 and the other end connected to a pivot (not shown) in the groove 12, a tension spring 31 connected at one end to the jaw 30 and at the other end to a connector (not shown) within the handle 10, a quick release 25 pivotably connected to the moveable handle 20 at a rivet 24, and an adjusting screw 13 projected from the rear end of the fixed handle 10.

The pliers further comprises a first pad 40 in the form of a sheet adapted to form over the fixed handle 10 by applying adhesive thereonto and a second pad 50 in the form of a sheet adapted to form over the moveable handle 20 by applying adhesive thereonto in which each of the pads 40 and 50 is produced separately and is formed of a soft polymeric material (e.g., EVA (ethylene vinyl acetate)) for providing the user with a degree of comfort while using the pliers. Moreover, each of the pads 40 and 50 is shaped to conform to the contour of a corresponding handle. Thus, the substantially rectangular first pad 40 comprises a slightly increased first section 41 for disposing over a portion of the fixed handle 10 ranged from about the other end of the toggle link 23 to a front end of the gap 14, and a slightly further increased second section 42 for disposing over the rear end of the fixed handle 10 with the gap 14 being not enclosed. Further, the substantially trapezoidal second pad 50 comprises an indent 51 at either side so as to leave the rivet 24 open when the second pad 50 is disposed over the moveable handle 20. It is appreciated that the pad can have a pleasing color so that the formed pliers has an aesthetic appearance.

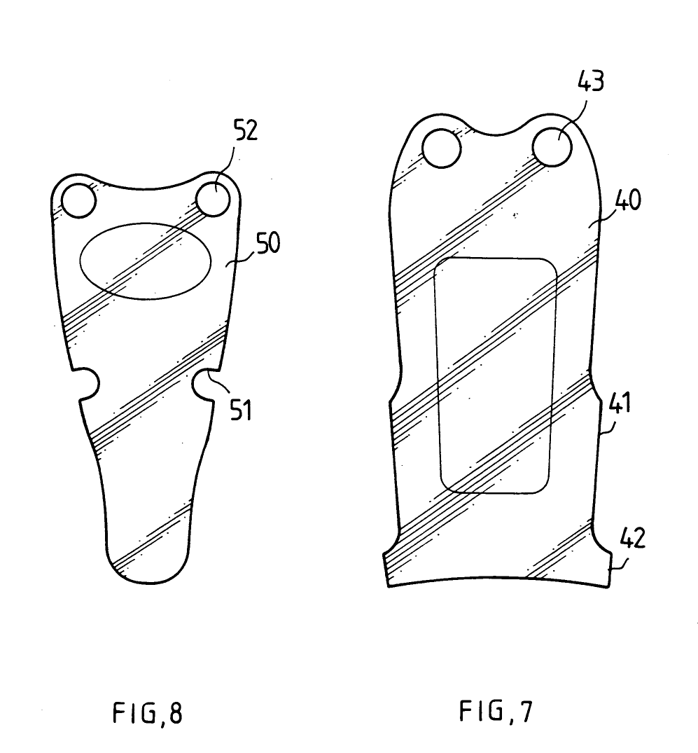

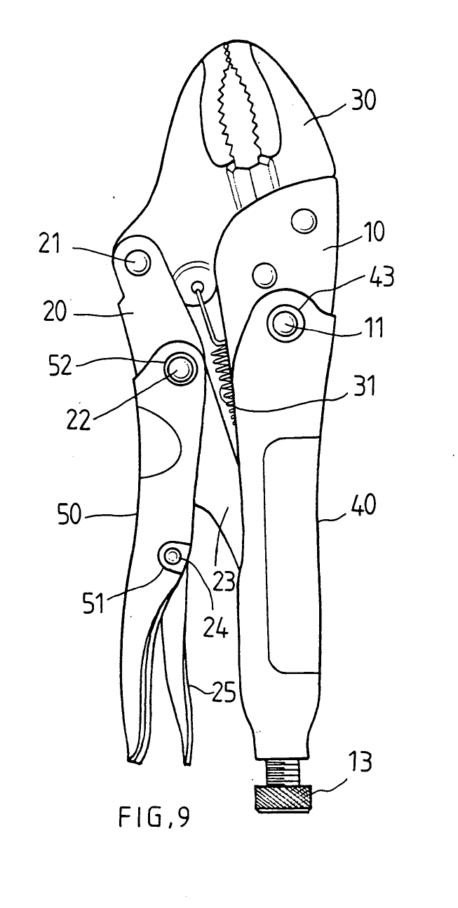

Referring to FIGS. 7 to 9, a second preferred embodiment of the invention is shown. The second preferred embodiment substantially has same structure as the first preferred embodiment. The differences between these two preferred embodiments, i.e., the characteristics of the second preferred embodiment are detailed below. Each of the pads 40 and 50 is enlarged for disposing over a larger portion of the handle. The first pad 40 further comprises at one end two spaced holes 43 for leaving the rivet 11 open when the first pad 40 is disposed over the moveable handle 20. The second pad 50 further comprises at one end two spaced holes 52 for leaving the rivet 22 open when the second pad 50 is disposed over the fixed handle 10.

While the invention herein disclosed has been described by means of specific embodiments, numerous modifications and variations could be made thereto by those skilled in the art without departing from the scope and spirit of the invention set forth in the claims.

1. A pliers, comprising:
first and second handles each having a U-shaped section;
two serrated jaws secured to the handles; and
first and second pads in the form of sheet disposed over the first and second handles respectively.

2. The pliers of claim 1, wherein the pads are formed of a polymeric material.

3. The pliers of claim 2, wherein the polymeric material is EVA.

4. A locking pliers, comprising:
first and second handles each having a U-shaped section wherein the first handle is fixed and the second handle is moveable;
first and second serrated jaws wherein the first jaw is fixedly secured to the first handle and the second jaw is pivotably secured to the first and second handles;
a toggle link pivotably interconnected the first and second handles;
resilient means connected at one end to the second jaw and at the other end to the first handle;
a quick release pivotably connected to the second handle;
an adjusting screw projected from a rear end of the first handle; and
first and second pads in the form of sheet disposed over the first and second handles respectively.

5. The pliers of claim 4, wherein the pads are formed of a polymeric material.

6. The pliers of claim 5, wherein the polymeric material is EVA.

7. The pliers of claim 4, wherein the first handle comprises a lengthwise gap at a reduced rear end.

8. The pliers of claim 7, wherein the first pad is substantially rectangular and includes an increased first section disposed over a portion of the first handle ranged from about the toggle link to a front end of the gap, and a second section larger than the first section disposed over the rear end of the first handle with the gap being not enclosed.

9. The pliers of claim 8, wherein the first pad further comprises at one end two spaced holes for leaving a joint of the first and second jaws open when the first pad is disposed over the first handle.

10. The pliers of claim 4, wherein the second pad is substantially trapezoidal and comprises an indent at either side for leaving a joint of the second handle and the quick release open when the second pad is disposed over the second handle.

11. The pliers of claim 10, wherein the second pad further comprises at one end two spaced holes for leaving a joint of the second handle and the toggle link open when the second pad is disposed over the second handle.
